(19) United States
(12) Patent Application Publication
(10) Pub. No.: US 2026/0192791 A1
(43) Pub. Date: Jul. 9, 2026

(54) Air bypass to augment air cushion vehicle

(71) Applicant: Celerity Craft, Inc., Squamish (CA)

(72) Inventors: Richard MacKellar, Squamish (CA); Saman Lak, Vancouver (CA); Xavier Bernard, Squamish (CA)

(21) Appl. No.: 19/091,738

(22) Filed: Mar. 26, 2025

Related U.S. Application Data
(60) Provisional application No. 63/742,764, filed on Jan. 7, 2025.

(51) Int. Cl. B60V 1/15; B60V 1/08; B60V 1/18

(52) U.S. Cl. CPC B60V 1/15; B60V 1/08; B60V 1/18

(57) ABSTRACT

Air cushion vehicles traditionally have distinct systems for lift and thrust. Combining the two systems has benefits but generally leads to compromised performance as there are limited ways to balance the forces. With the disclosed dynamic air cushion vehicle, ram air is added to the air cushion through a controlled opening in a variable seal at the bow. Firstly, this adds pressurized airflow to the air cushion, which reduces the power demand on the fan. Secondly, it provides an additional degree of control over the pressure and flow of the air cushion, which allows further optimization of vehicle efficiency and performance.

### TECHNICAL FIELD

This application relates to air cushion vehicles. In particular, the invention involves using the ram effect to provide additional air to the cushion.

### BACKGROUND

Air cushion vehicles (ACV) can take different forms. Firstly, the most common version is the hovercraft, in which a fan system is pointed down to inflate a skirt and provide lift forces while another set of fans is pointed backwards to provide thrust. Secondly, rigid hulls can be used instead of skirts to contain the air cushion. This version is generally embodied as a catamaran, in which seal systems are added to the bow and stern. These can be referred to as surface effect ships (SES) or sidewall hovercrafts. A fan system is used to pressurize the air cushion but thrust traditionally comes from water propulsion methods. Thirdly, aircraft flying low enough can benefit from a ground effect to supplement their lift. These vehicles typically travel over water surfaces and are referred to as wing-in-ground, or WIG vehicles. A famous implementation of this concept comes from Russia with the development of the Ekranoplan.

In all the three forms mentioned above, an air cushion exists between the vehicle and the running surface, which is typically water. This cushion either reduces drag (D) or improves the lift (L), and in both cases the desired result is an improved L/D ratio.

A fourth form of air cushion vehicle (ACV) is described in U.S. Pat. No. 3,342,278 to Cocksedge. Cocksedge's ACV is a trimaran, having three hulls and two air chambers between them. It may be referred to as a sidewall hovercraft but has key distinctions from a traditional SES. In this form of ACV, both the lift and thrust forces come from the action of the same fan system. Fans are located at the bow of the vehicle and above the wet deck, pushing air into the air chambers through a duct or ducts such that it passes air through the deck from above and into the air chambers beneath. The action of the fans increases the air cushions' pressure in the air chambers, providing lift to the vehicle, and a controlled release of the pressure at the stern provides thrust.

The top of the air chamber is defined by the underside of the deck, known as the wet deck, and the bottom is defined by the surface that the ACV travels over, typically water. The sides of the air chamber are defined by the hulls of the vessel. Bow plates are used to seal the front of the air chambers, and stern plates to seal the rear of the air chambers.

The combined lift and thrust action coming from a single fan system is a differentiation from hovercrafts, SESs, and WIGs. This introduces notable advantages but also introduces the problem that fan performance becomes compromised. The fan regime can either be optimized for lift or thrust, not both.

U.S. Pat. No. 3,342,278 to Cocksedge explains that, during the forward motion of the ACV, the bow plates remain in their fully lowered position. The plates are hinged to allow waves to pass through with minimal interference, with the plates remaining in contact with the waves. When reversing, the bow plates are opened but are otherwise intended to create a complete seal against the water surface during all forward motion of the craft. The plates sealing the air cushion cause aerodynamic drag, as well as hydrodynamic drag when they contact the water. Additionally, waves contacting the plates may result in slamming vibrations that are felt by ACV occupants. A properly designed hinge system can reduce these negative effects, but only up to a certain point given that this architecture requires the plates to have constant contact with water.

Regarding the problems of prior ACVs, consider an ACV in which the same fan system is intended to provide both lift and thrust. For the ACV to operate effectively, pressure within the air chamber needs to be maintained to an adequate level to sustain the lift of the ACV. Simultaneously, achieving fuel efficient cruise speeds requires the energy used for thrust forces to be optimized. However, the fan regime that is best to maintain lift is not necessarily optimal for thrust, and vice versa, hence compromising efficiency. A typical prior art fan curve such as that shown in FIG. 1 presents a relation between static pressure P of the fan and its air flow rate Q. The value P is pressure differential, or the output pressure of the fan minus the input pressure of the fan. For a given fan RPM (revolutions per minute), increasing the pressure decreases flow, and vice versa. When the fan is generating maximum output pressure Pmax, its flow rate is zero. As the pressure P falls to zero, e.g. when the fan is blowing into an unrestricted space, its flow rate is a maximum, Qₘₐₓ.

Next, consider a prior art ACV such as a sidewall hovercraft with a fan 8 located at the bow of the craft, as illustrated in FIG. 2. This ACV has an adjustable opening and seal system 9 at the stern, such as a plate on hinges, and a fully sealed bow 10.

In this schematic, \dot{m}, P, and v denote mass flow rate, pressure, and velocity, respectively, where the subscript f denotes parameters relating to the air blown through the fan into the air cushion and the subscript out denotes air expelled from the rear of the air cushion.

Assuming that the sidewalls 11 provide an effective seal, input 12 to the air cushion comes from the fan 8, and output 14 occurs through the controlled opening 16 of the stern seal 9. The thrust (T) is defined by the difference between the air inflow and air outflow momentum flux:

$$T = ( {\dot{m}}_{out} {v}_{out} + {P}_{out} {A}_{out} ) - ( {\dot{m}}_{f} {v}_{f} cos {θ}_{f} + {P}_{f} {A}_{f} cos {θ}_{f} ) \qquad ( 1 )$$

Here, the angle θ is the angle between the axis of the fan and the horizontal, P_{f} denotes the pressure at the inlet of the fan, and Pₒᵤₜ is the pressure at the outlet of the system. A_{f} is the fan disk surface area, and Aₒᵤₜ is the area of the opening by the stern seal. When the values of P are measured as a difference relative to the atmosphere, Pₒᵤₜ is zero.

In fluid mechanics the total pressure, also known as stagnation pressure, corresponds to the sum of the static pressure and dynamic pressure. When evaluating the lift force on the vehicle exerted by air pressure, the air flow runs parallel to the wet deck and has no net vertical component. Therefore, it is the static pressure which needs to be considered, multiplied by its effective area in a horizontal plane. The static pressure also correlates directly to the pressure generated by the fan. Depending on the flow going through the system, the fan will have a different operating point on the fan curve. FIG. 3 shows a prior art example of the operating point of such a fan, which is operating at a flow rate of Q₁ to maintain a lift pressure of P_{req}.

The engineering intent for the ACV is for it to rely on air pressure as the primary force to sustain its lift, instead of buoyancy and hydrodynamic forces, or contact forces with the ground. As the weight of the vehicle remains constant during operation, the lift pressure should be kept constant. As a result, with a fully sealed bow, the lift and thrust are coupled and cannot be independently controlled. The operator of the vehicle who wants to accelerate or decelerate has three options to modify the thrust. The first is to change the fan RPM, which will shift the operating point to a different curve with different P and Q values. However, this also affects the power and efficiency of the fan. The second option, if applicable, is to modify the fan's blade pitch. This will have a similar impact on the system as modifying the RPM. The third option is to change the aperture of the stern seal to let more or less air escape. Given that thrust corresponds to Eq. (1), and while this can effectively change the thrust, the lift will also change. The additional air exhausted or retained therefore needs to be compensated for by adjusting the fan. Operating such an ACV requires frequently balancing the two parameters.

This background is not intended, nor should it be construed, to constitute prior art against the present invention.

### SUMMARY OF INVENTION

For the remainder of this document, we will refer to a dynamic air cushion vehicle (DACV). In the present disclosure, some key nuances compared to the fourth type of ACV are introduced into the bow and seal of the DACV. While U.S. Pat. No. 3,342,278 suggested using hinged plates at the bow and seal, the DACV architecture described in this invention involves a variable seal system at the bow and stern, which may include hinged plates or other seal technologies. One key aspect of the architecture, which is cornerstone to the invention presented herein, is that those seal systems have actuation mechanisms or control allowing the characteristics of the opening to be varied. While the DACV is in motion, a controlled opening at the bow allows ram air to supplement the air cushion. This has notable effects on the system. By bypassing the fans, the additional air input augments the energy in the cushion, as well as opening up possibilities of balancing the system, resulting in overall increased vehicle efficiency of the DACV.

The disclosed invention applies to DACVs, which are a specific type of ACV. Prior art covers the general architecture which can be summarized as having hulls as rigid sidewalls to contain the cushion, seal systems at the bow and stern, and fans located above the wet deck to push air into the cushion, providing a combination of lift and thrust. In contrast, the currently claimed invention is that, as the DACV is in motion, the bow seal has a controlled opening to allow ram air to enter the cushion, bypassing the fans. This dual intake of air, one via fans and one via the ram effect through the bow, augments the air cushion's characteristics. In addition to further improving performance compared to ACVs that do not leverage the ram effect, the dual intake allows resolution of the compromise necessitated when a single fan system provides a combined lift and thrust.

Having two independent inputs contributing to the air cushion enables the pressure and flow of the air cushion to be maintained at desired values, or to be adjusted, while maintaining the fan regime at a level which is optimal for the overall system efficiency.

Disclosed herein is a method of operating a DACV, the DACV having a fan, an air cushion, an adjustable bow seal and an adjustable stern seal, the method comprising: drawing air into the air cushion via the fan; drawing ram air into the air cushion via a controlled opening in the adjustable bow seal; and expelling the air and the ram air from the air cushion via another controlled opening, which is in the adjustable stern seal.

Also disclosed is a DACV comprising: a fan that blows air into an air cushion; an adjustable bow seal with a controlled opening that controls a flow of ram air into the cushion; an adjustable stern seal, with another controlled opening, which controls a flow of the air and the ram air out of the air cushion; and a control unit that controls a rotational speed of the fan and/or a blade pitch of the fan, the controlled opening of the adjustable bow seal, and the controlled opening of the adjustable stern seal.

This summary provides a simplified, non-exhaustive introduction to some aspects of the invention, without delineating the scope of the invention.

### BRIEF DESCRIPTION OF DRAWINGS

The following drawings illustrate embodiments of the invention and should not be construed as restricting the scope of the invention in any way.

FIG. 1 is a typical, prior art fan curve of pressure versus flow for a given RPM.

FIG. 2 is a schematic cross-sectional view of a prior art ACV with sealed bow.

FIG. 3 is a typical, prior art fan curve of pressure versus flow for a given RPM, identifying a specific operation point.

FIG. 4 is a schematic cross-sectional view of a DACV with an adjustable bow seal, according to an embodiment of the present invention.

FIG. 5 is a fan curve of pressure versus flow for a given RPM identifying the effect of ram air, according to an embodiment of the present invention.

FIG. 6 is a fan curve of pressure versus flow for a given RPM identifying an additional effect of ram air, according to an embodiment of the present invention.

FIG. 7 is a method of operating a DACV, according to an embodiment of the present invention.

FIG. 8 is a schematic block diagram of a control system for a DACV, according to an embodiment of the present invention.

FIG. 9 is a flow chart of exemplary steps used in the control of a DACV, according to an embodiment of the present invention.

FIG. 10 is a flow chart of other exemplary steps used in the control of a DACV, according to an embodiment of the present invention.

FIG. 11 is a flow chart of further exemplary steps used in the control of a DACV, according to an embodiment of the present invention.

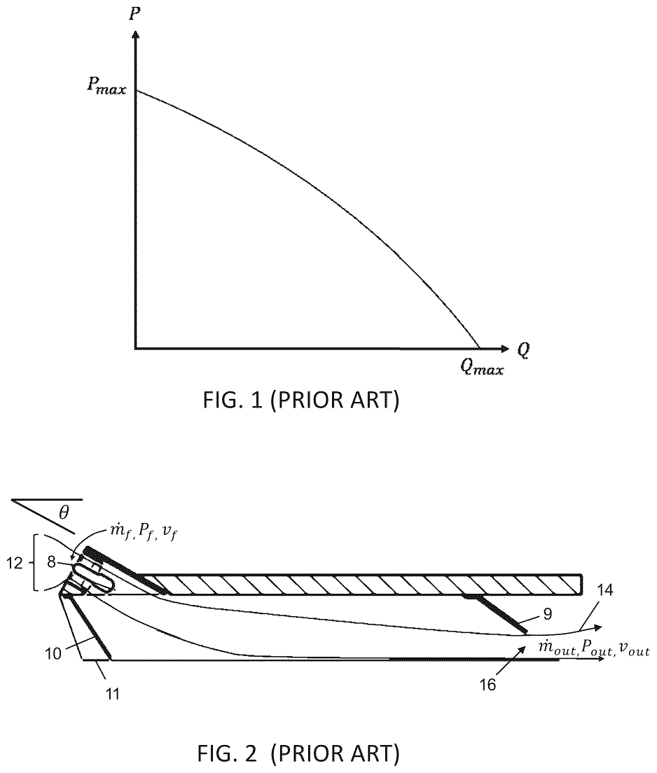

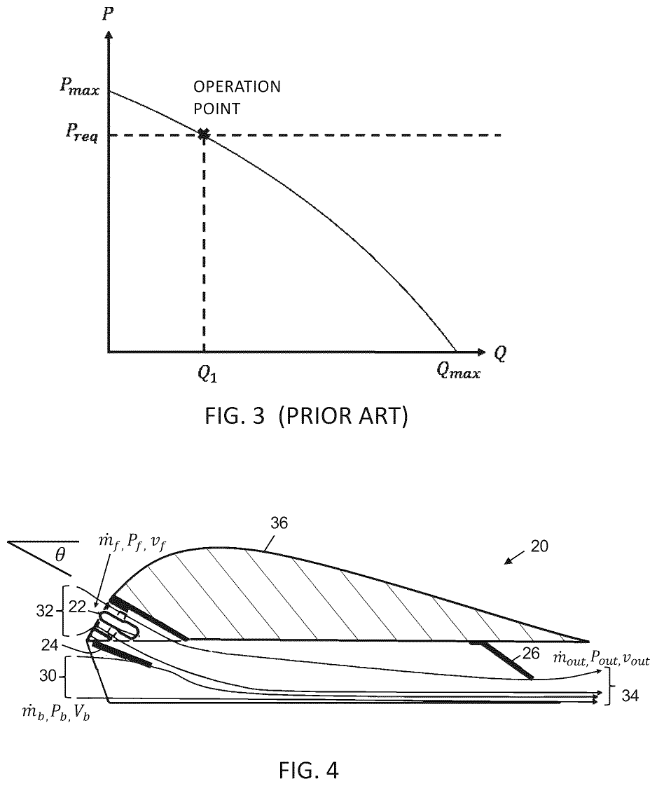

### DETAILED DESCRIPTION

Controlling two output variables independently (thrust and lift, or pressure and flow), requires having at least two distinct input variables. To resolve the problem of relying on a single fan as the sole input for a single air cushion, this invention involves adding ram air pressure to the fan's flow into the air cushion. By having a variable aperture, i.e. a controlled opening, for the bow seal, it becomes possible to control the flow of ram air into the air cushion in the air chamber as the DACV travels forward. The control of the ram air acts as the second input variable to balance the system.

Referring to FIG. 4, consider a DACV 20 with a fan system 22 located at the bow. In this DACV, each of the adjustable bow seal 24 and adjustable stern seal 26 have a variable, controlled opening or aperture, each allowing for the controlled flow of air through the aperture. The seal of the bow seal may be complete or partial, or the bow seal may be fully open. The seal may extend along the upper edge of the bow seal, or along the upper edge and continue down both sides, either partially or fully. When fully sealed, the seals extend around the top and sides, and the bottom edge of the bow seal is sealed to the water or other surface over which the DACV travels. The same applies to the stern seal. If the speed of the DACV is high enough, as will be defined below, the ram air intake 30 at the bow acts as a second input to the system, supplementing the action of the fan 22 and its corresponding air intake 32.

Adjusting the controlled opening at the bow based on the DACV speed, as proposed in this invention, may have two benefits. Firstly, it brings more energy to the air cushion system, meaning more energy is available for lift and/or thrust without increasing the energy demand by the fan system. Secondly, it provides a way of modifying the lift and/or thrust without modifying the fan's RPM or blade angle. This dissociation removes the compromise between lift and thrust mentioned above, and allows the DACV to keep the fan running in its optimal operating regime.

As shown in FIG. 4, an inflow of air 30 occurs at the bow opening, referred to as ram air, in addition to the fan inflow 32. The combination of the two inflows of air leads to an outflow 34 of air through the adjustable stern seal 26. The addition of the ram inflow leads to an enhancement in thrust due to a combination of effects it causes. The conservation of mass dictates:

$${\dot{m}}_{out} = {\dot{m}}_{f} + {\dot{m}}_{b} \qquad ( 2 )$$

Assuming that the mass flow rate \dot{m}_{f} of the fan does not change when the bow is opened, an increase in outflow mass flow rate \dot{m}ₒᵤₜ is caused by the addition of the bow inlet flow \dot{m}ₚ. This increase in \dot{m}ₒᵤₜ leads to an increase in the speed vₒᵤₜ of the the air leaving the air cushion, potentially enhancing the thrust.

In more detail, the thrust in this case is calculated as:

$${T}^{′} = ( {\dot{m}}_{out} {v}_{out} + {P}_{out} {A}_{out} ) - ( {\dot{m}}_{f} {v}_{f} cos {θ}_{f} + {P}_{f} {A}_{f} cos {θ}_{f} ) - ( {\dot{m}}_{b} {v}_{b} + {P}_{b} {A}_{b} ) \qquad ( 3 )$$

where T′ represents the thrust in the open-bow case, v_{f} denotes the speed of the air at the inlet of the fan, θ_{f} denotes the angle between the fan's axis and the horizontal direction and vₚ denotes the speed of the air entering through the bow aperture.

It is assumed that Pₚ and Pₒᵤₜ are equal to the atmospheric pressure. This brings their value to zero and simplifies the equation:

$${T}^{′} = {\dot{m}}_{out} {v}_{out} - {\dot{m}}_{f} {v}_{f} cos {θ}_{f} - {P}_{f} {A}_{f} cos {θ}_{f} - {\dot{m}}_{b} {v}_{b} \qquad ( 4 )$$

The mass flow rate at each section can be related to its flow velocity v and cross-sectional area A using the relation \dot{m}=ρ.v.A, where ρ is the air density. Using this relation to substitute

$$\frac{\dot{m}}{ρ A}$$

for velocity values in the simplified thrust Eq. (4) given above results in:

$${T}^{′} = \frac{{( {\dot{m}}_{f} + {\dot{m}}_{b} )}^{2}}{ρ {A}_{out}} - \frac{{\dot{m}}_{f}^{2}}{ρ {A}_{f}} cos {θ}_{f} - {P}_{f} {A}_{f} cos {θ}_{f} - \frac{{\dot{m}}_{b}^{2}}{ρ {A}_{b}} \qquad ( 5 )$$

Therefore, assuming that the fan operating point is the same in both cases, the difference ΔT between the thrust exerted in this case with the thrust exerted in the sealed-bow case is:

$$Δ T = {T}^{′} - T = \frac{{( {\dot{m}}_{f} + {\dot{m}}_{b} )}^{2}}{ρ {A}_{out}} - \frac{{\dot{m}}_{f}^{2}}{ρ {A}_{out}} - \frac{{\dot{m}}_{b}^{2}}{ρ {A}_{b}} \qquad ( 6 )$$

### Hence:

$$Δ T = \frac{{\dot{m}}_{b} ( 2 {\dot{m}}_{f} + {\dot{m}}_{b} )}{ρ {A}_{out}} - \frac{{\dot{m}}_{b}^{2}}{ρ {A}_{b}} \qquad ( 7 )$$

If ΔT>0, it can be concluded that opening the bow leads to an increase in the thrust. This condition is satisfied if:

$$\frac{2 {\dot{m}}_{f} + {\dot{m}}_{b}}{{A}_{out}} > \frac{{\dot{m}}_{b}}{{A}_{b}} \qquad ( 8 )$$

which can be simplified to:

$${\dot{m}}_{f} > \frac{1}{2} {\dot{m}}_{b} ( \frac{{A}_{out}}{{A}_{b}} - 1 ) \qquad ( 9 )$$

If Aₒᵤₜ<A_{b}, this condition is unconditionally satisfied. When Aₒᵤₜ>A_{b}, care should be taken in adjusting the fan and bow inlet flow rate \dot{m}ₚ for this condition to be satisfied.

As a first example, consider a prototype with a length L of 1.0 m, beam B of 46 cm, air cushion height h_{c} of 120 mm and air cushion width w_{c} of 180 mm. Assume that the wet deck runs parallel to the water surface, meaning that the total height at the bow and stern are the same. Assume that the air entering the air cushion from the bow has the same speed as the DACV, i.e. there is no wind. Assume that the cruising speed is 7.5 m/s, that the stern flap is 80% open (Stern Opening Ratio=0.8) and that the bow flap is 100% open (Bow Opening Ratio=1.0). We then have:

$${A}_{out} = {w}_{c} \times {h}_{c} \times Stern Opening Ratio = 0.01728 {m}^{2}$$

$${A}_{b} = {w}_{c} \times {h}_{c} \times Bow Opening Ratio = 0.0216 {m}^{2}$$

$${\dot{m}}_{b} = {ρ}_{air} \cdot {v}_{craft} \cdot {A}_{b} = 1.205 \times 7.5 \times 0.0216 = 0.195 kg / s$$

The value of \dot{m}_{f} is calculated from the fan curve, which determines the fan static pressure as a function of volumetric flow rate Q_{f}. The mass flow rate is calculated as:

$${\dot{m}}_{f} = {ρ}_{air} \cdot {Q}_{f}$$

As an example:

$${Q}_{f} = 0.06 {m}^{3} / s$$

### Hence:

$${\dot{m}}_{f} = {ρ}_{air} \times {Q}_{f} = 1.205 \times 0.06 = 0.0 \; 723 kg / s$$

Checking the condition of Eq. (9), we can see that it is clearly satisfied:

$$\frac{1}{2} {\dot{m}}_{b} ( \frac{{A}_{out}}{{A}_{b}} - 1 ) = 0.5 \times 0.195 \times ( \frac{0.01728}{0.0216} - 1 ) = - 0.0 \; 195 kg / s$$

To provide a second example, for example where the above condition is not satisfied, let us assume that the bow flap is lowered in the first example so that the bow is 40% open (Bow Opening Ratio=0.4). Therefore:

$${A}_{b} = {w}_{c} \times {h}_{c} \times Bow Opening Ratio = 0.00864 {m}^{2}$$

$${\dot{m}}_{b} = {ρ}_{air} \cdot {V}_{craft} \cdot {A}_{b} = 1.205 \times 7.5 \times 0.00864 = 0.0 \; 781 kg / s$$

Hence, from Eq. (9):

$$\frac{1}{2} {\dot{m}}_{b} ( \frac{{A}_{out}}{{A}_{b}} - 1 ) = 0.5 \times 0.0781 \times ( \frac{0.01728}{0.00864} - 1 ) = 0.0781$$

Comparing with my:

$${\dot{m}}_{f} = 0.0723 < 0.0781 = \frac{1}{2} {\dot{m}}_{b} ( \frac{{A}_{out}}{{A}_{b}} - 1 )$$

As evident, the condition of Eq. (9) is not satisfied in this case. In this scenario, reducing the stern opening or increasing the bow opening would resolve the issue.

As a third example, consider a 12-passenger water taxi with the following dimensions: the length Lis 11.9 m, the beam B is 5.0 m, the air cushion height h_{c} is 1.25 m and the air cushion width w_{c} is 1.75 m. Assume that wet deck runs parallel to the water surface, meaning that total height at the bow and stern are the same. Assume that the air entering the air cushion from the bow has the same speed as the vehicle, i.e. there is no wind. Assume a cruising speed of 20.58 m/s (40 kt), that the stern flap is 60% open (Stern Opening Ratio=0.6) and that the bow flap is 80% open (Bow Opening Ratio=0.8). We then have:

$${A}_{out} = {w}_{c} \times {h}_{c} \times Stern Opening Ratio = 1.31 {m}^{2}$$

$${A}_{b} = {w}_{c} \times {h}_{c} \times Bow Opening Ratio = 1.75 {m}^{2}$$

$${\dot{m}}_{b} = {ρ}_{air} \cdot {V}_{craft} \cdot {A}_{b} = 1.205 \times 20.58 \times 1.75 = 43.4 kg / s$$

The value \dot{m}_{f} is calculated from the fan curve, which determines the fan static pressure as a function of volumetric flow rate Q_{f}. The mass flow rate is calculated as:

$${\dot{m}}_{f} = {ρ}_{air} \cdot {Q}_{f}$$

As an example:

$${Q}_{f} = 33.7 {m}^{3} / s$$

### Hence:

$${\dot{m}}_{f} = {ρ}_{air} \times {Q}_{f} = 1.205 \times 33.7 = 40.6 kg / s$$

Checking the condition of Eq. (9), we can see that it is clearly satisfied:

$$\frac{1}{2} {\dot{m}}_{b} ( \frac{{A}_{out}}{{A}_{b}} - 1 ) = 0.5 \times 43.4 \times ( \frac{1.31}{1.75} - 1 ) = - 5.46 < 0$$

In a fourth example, let us assume a different bow and stern opening configuration of the third example, where the bow opening is smaller than the stern opening ratio. Assume that the stern flap is 80% open (Stern Opening Ratio=0.8) and the bow flap is 40% open (Bow Opening Ratio=0.4). We then have:

$${A}_{out} = {w}_{c} \times {h}_{c} \times Stern Opening Ratio = 1.75 {m}^{2}$$

$${A}_{b} = {w}_{c} \times {h}_{c} \times Bow Opening Ratio = 0.875 {m}^{2}$$

$${\dot{m}}_{b} = {ρ}_{air} \cdot {V}_{craft} \cdot {A}_{b} = 1.205 \times 20.58 \times 1.75 = 21.7 kg / s$$

Assuming the same fan flow rate:

$${\dot{m}}_{f} = 40.6 kg / s$$

Checking the condition of Eq. (9):

$$\frac{1}{2} {\dot{m}}_{b} ( \frac{{A}_{out}}{{A}_{b}} - 1 ) = 0.5 \times 21.7 \times ( \frac{1.75}{0.875} - 1 ) = 21.7$$

Comparing with \dot{m}_{f}:

$${\dot{m}}_{f} = 40.6 > 21.7 = \frac{1}{2} {\dot{m}}_{b} ( \frac{{A}_{out}}{{A}_{b}} - 1 )$$

Therefore, we can see that the condition of Eq. (9) is clearly satisfied.

Eqs (2)-(9) relate to the enhancement of thrust as a result of ram air intake, and as speed increases, drag will eventually limit the maximum speed. Also of note in the DACV 20 is the aerofoil-shaped roof 36, which provides additional lift at speed, allowing for a further increase in efficiency of the vehicle.

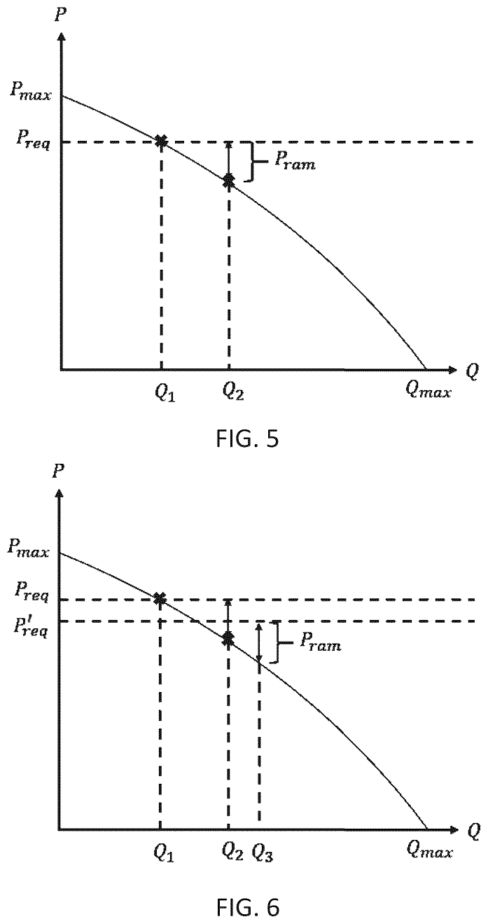

A second positive effect of the bow inflow, in addition to the energized air it brings to the air cushion, is that it changes the operating point of the fan. The ram pressure provides a portion of the required pressure P_{reg} for the air cushion, which allows for the fan operating point to be moved towards lower pressure and higher flow rates, e.g. Q₂ as shown in FIG. 5. In this case, P_{reg}=Pᵣₐₘ+P_{f}. Increasing the volumetric flow rate of the fan leads to an increase in the fan mass flow rate \dot{m}_{f}, which further increases the generated thrust.

A third positive effect of the bow opening introduced into the DACV leads to the addition of aerodynamic lift to the system. The effect of this aerodynamic lift is the reduction of the required pressure from

$${P}_{req} to {P}_{req}^{′} .$$

The reduction in the required pressure allows a further increase in the fan flow rate, e.g. to Q₃ as in FIG. 6, which in turn allows for further performance enhancement based on the process explained above. Moreover, the proximity of the wet deck to the water surface leads to an enhanced aerodynamic lift due to the ground effect. In this case, the ground effect improves the aerodynamic lift force and lift-to-drag ratio, increasing the efficiency of the operation of the ACV. Both the hydrodynamic and aerodynamic drag components of prior art ACVs are alleviated by the system presented in this invention.

A fourth positive effect of the controllable bow opening introduced in the DACV is the reduction of hydrodynamic drag. When a traditional sidewall hovercraft operates in choppy and rough waters, the waves touching the bow sealing device contribute to drag and, depending on severity, may negatively impact the occupants' comfort. When a DACV such as a sidewall hovercraft is configured as suggested in the current invention, the bow sealing device maintains an air gap between its lower edge and the water surface. This ensures the hydrodynamic drag components associated with the bow seal system are reduced to zero. This improves the seakeeping performance of the craft by reducing the heaving and pitching associated with hydrodynamic forces at the bow seal.

A fifth positive effect is the reduction of aerodynamic drag associated with the front seal system. As the opening increases, the projected area of the seal is reduced, hence reducing its resistance to air compared to a fully sealed bow.

A sixth positive effect is that the variable seal at the front introduces forces (aerodynamic lift) which can assist with trimming the attitude of the DACV. Adjustment of the ram air may also contribute to shifting the average center of pressure within the air cushion (center of lift), further helping with trim adjustments. This allows for greater stability of the DACV.

A seventh effect relates to the fact that navigating the vehicle over waves, or any uneven surface, can result in fluctuation of the air cushion volume. This can in turn impact the pressure and flow, which can then impact the vehicle's attitude and overall dynamics. The negative effects can be canceled if the DACV's system is capable of compensating for the change of pressure. One of the challenges is that these fluctuations may have a frequency higher than that which can be handled by varying the fan speed alone. The DACV, with its adjustable bow and stern seal system, is more capable of handling rapid fluctuations than traditional ACVs with a fully sealed bow.

In order to minimize unwanted air leaks, care should be taken to achieve a good level of fabrication tolerance at the bow and/or stern seal systems. Also, correct control of the variable bow and/or stern seal systems should be employed. Too high of an air cushion pressure lifting the ACV may cause excessive leaks through daylight gaps underneath the hulls, although some leakage here is essential in achieving a complete hover.

An uneven ground or water surface may lead to imperfect contact with the hulls or seal system, resulting in unwanted air leakage. As well, an uneven attitude of the DACV (pitch or roll angle), leading to imperfect contact between the hulls and water or ground surface, will lead to excessive leakage.

An exemplary DACV configuration has three hulls side by side and a wet deck that together define two plena between the hulls, the wet deck and the water. A fan or fans take in airflow at the bow of the DACV from above the wet deck to avoid the fans operating in the water zone. The fan or fans direct the air flow through ducts into the plena below the wet deck. In some embodiments, the fans may be at the side of the DACV or on the side hulls. The air flow and pressure in each plenum is independently controllable.

The adjustable stern seal system can consist of a hinged flap with actuators to adjust its position. This modulates the air flow escaping at the stern to provide a trade-off of lift pressure and thrust.

The adjustable bow seal system can consist of a hinged flap with actuators to adjust its position. When the DACV is stationary or at low speed, this seal is typically shut to contain the air in the respective plenum, allowing it to be pressurized and provide lift to the DACV. As the vehicle speed increases, the ram pressure of the incoming air builds up, which can resist the tendency of the pressurized air within the plenum to exit through the aperture at the bow flap. Therefore, as the speed increases, the adjustable bow flap can be gradually opened while remaining effective at maintaining pressurized air inside the air cushion. The potential to open the bow flap increases with the square of speed, due to the amount of ram air pressure and aerodynamic lift being proportional to v².

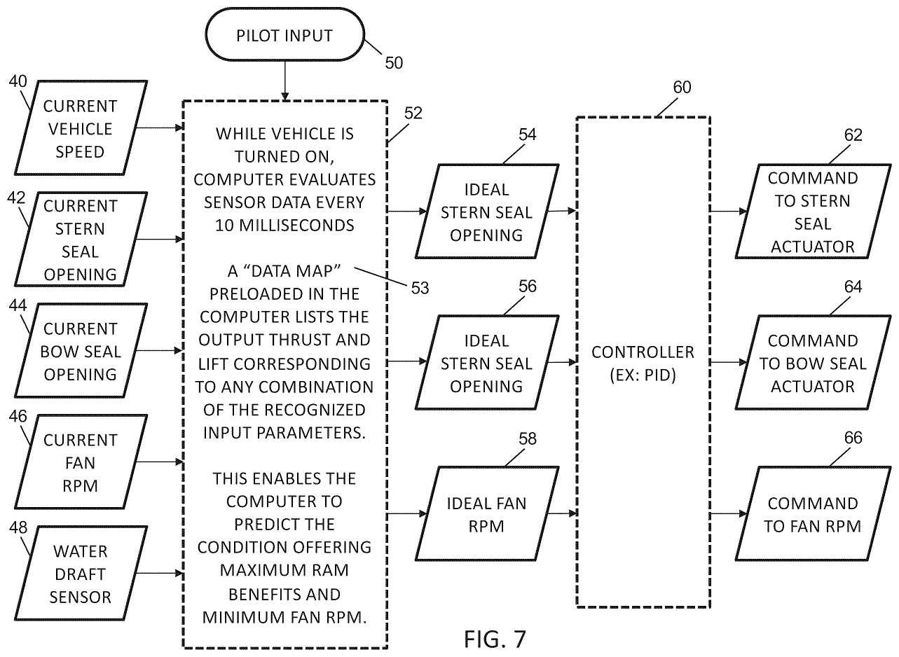

Referring to FIG. 7, an exemplary method of operating a DACV is shown. While the vehicle is in operation, for example as the result of a pilot's input 50 of a desired speed, the onboard computer 52 repeatedly (for example, every 10 milliseconds) reads sensor data and evaluates the ideal bow and stern seal opening, as well as fan RPM. Sensor data includes current DACV speed 40 from a speed sensor, current stern seal opening 42 from a stern seal opening sensor, current bow seal opening 44 from a bow seal opening sensor, current fan RPM 46 from a fan speed sensor, and current water draft 48 from a displacement sensor. A data map 53 preloaded in the computer 52 lists the expected output thrust and lift corresponding to any combination of the recognized input parameters as provided by the sensors. This enables the computer to predict which conditions maximize RAM air benefits and minimize fan RPM. These conditions are an ideal stern seal opening 54, an ideal bow seal opening 56 and an ideal fan RPM 58. These ideal values 54, 56, 58 are then passed to a controller 60 which, every 10 milliseconds, adjusts the signals sent to the stern seal actuator 62, the bow seal actuator 64 and the fan motor(s) 66. The controller 60 may be of the PID (proportional-integral-derivative) type, for example. Lowering the RPM is key to reducing the power requirements, and keeping energy consumption to a minimum.

In other embodiments, additional complexity is managed using the same principle. The DACV may have fans with a variable blade pitch and/or a variable air intake aperture. Actuated duct systems between the fans and the air cushions may also modify the airflow characteristics. Aerodynamic or hydrodynamic control surfaces may be located on any surface of the DACV. The effect of these additions are factored in by the predictive data model that is preloaded in the computer 52, and the DACV is still capable of managing its power consumption while meeting lift and thrust targets.

The load of the DACV may be taken into account in several ways. For example, the manufacturer's specification may provide the dry weight and full load weight of the DACV, and this range can be included in the data map 53 or as a modification to the data map in the computer 52. As another example, a sensor may measure the water level at the bow and stern while at rest to perform a calibration or reading of the DACV's displacement. Alternately, the DACV may have more complex sensors and a calibration procedure to evaluate the DACV's mass based on a more dynamic manoeuver. For example, a ballast inside the DACV is moved around and sensors measure the response, using the information to back calculate the actual mass of the DACV. Finally, the captain or pilot may enter the weight via a user interface of the DACV.

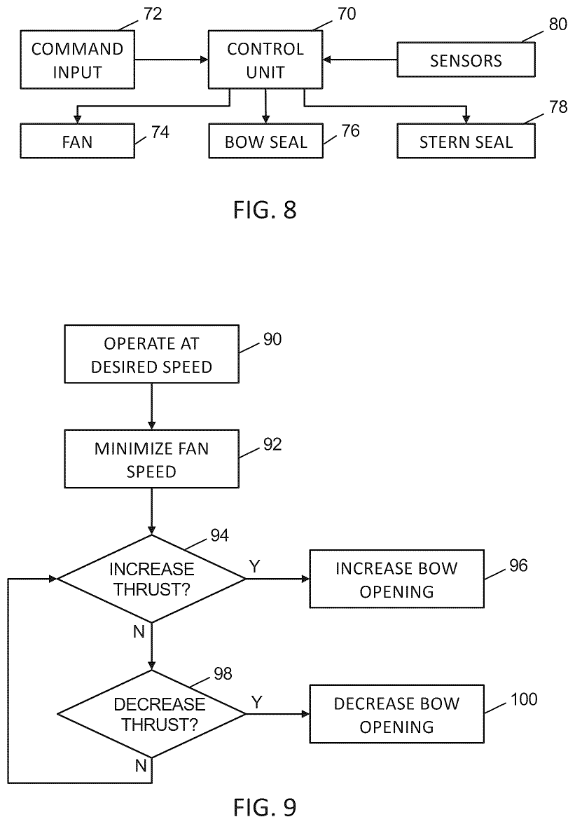

Referring to FIG. 8, an example of the DACV has a control unit 70, which takes a command input 72 that includes at least a desired DACV speed or thrust. In response, the control unit outputs signals to the fan 74 to control its RPM to the adjustable bow seal 76 to control its aperture and to open and close it, and to the adjustable stern seal to control its aperture and to open and close it. Sensors 80 are connected to the control unit 70 to provide feedback of the DACV speed. Other sensors may provide feedback representing the attitude of the DACV, pressure of the air cushion, wind pressure over the stern of the DACV, wind speed and/or wind direction, for example. While the DACV systems are active, the control unit 70 determines the combination of fan speed, stern seal aperture size, and bow seal aperture size that minimizes the fan's RPM for a desired lift and desired thrust.

The control unit may include one or more microprocessors, which execute computer readable instructions stored in a memory, in order to convert the command input to the desired DACV dynamics while optimizing the fan speed. The control unit may, for example, include the computer 52 and controller 60.

Referring to FIG. 9, specific steps are shown that an exemplary DACV undertakes. In step 90, the DACV is operated at a desired speed, for example via a pilot making an input via a user interface of the DACV. While operating at the desired speed, and assuming that conditions are suitable, the bow seal is set to be partially open. In step 92, the control unit minimizes the fan speed, as a result of the bow seal being open. This step may be performed gradually as the DACV achieves its desired speed. In step 94 it is determined whether the thrust of the DACV should be increased or not. If so, then in step 96 the controlled opening of the adjustable bow seal is increased, which results in an increase of the thrust of the DACV. If not, then in step 98 it is determined whether the thrust of the DACV should be decreased or not. If so, then in step 100 the controlled opening of the adjustable bow seal is decreased to result in a decrease of the thrust of the DACV. The process then reverts to step 94.

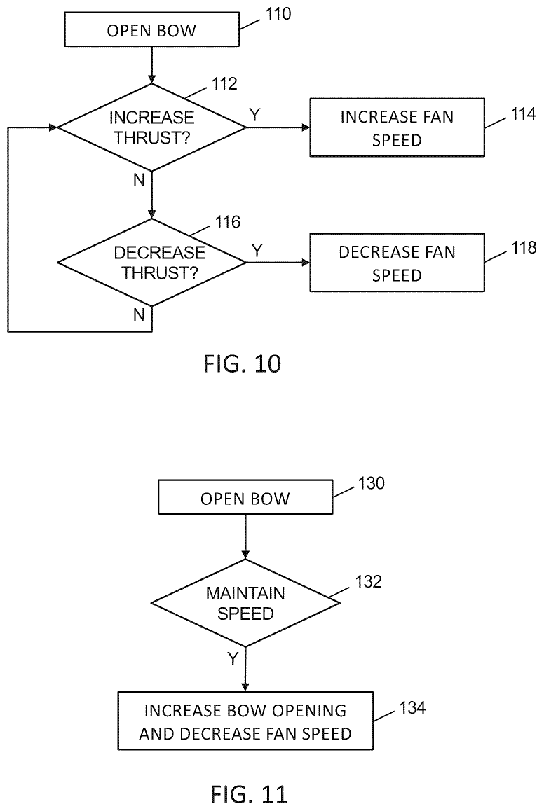

Referring to FIG. 10, more specific steps are shown that an exemplary DACV undertakes. In step 110, the adjustable bow seal of the DACV is opened, resulting from a determination that conditions are suitable for its opening. One of the conditions may be the speed of the DACV, although other factors may be included. In step 112 it is determined whether the thrust of the DACV should be increased or not. If so, then in step 114 the rotational fan speed is increased, which results in an increase of the thrust of the DACV. If not, then in step 116 it is determined whether the thrust of the DACV should be decreased or not. If so, then in step 118 the rotational fan speed is decreased to result in a decrease of the thrust of the DACV. The process then reverts to step 112.

Referring to FIG. 11, further specific steps are shown that an exemplary DACV undertakes. In step 130, the adjustable bow seal of the DACV is opened, resulting from a determination that conditions are suitable for its opening. In step 132, it is determined whether the speed of the DACV is to be maintained. If it is, then in step 134, the controlled opening in the adjustable bow seal is increased while the rotational speed of the fan is decreased.

In other embodiments, the DACV is a catamaran with a single air cushion, or it has more than three hulls and more than two air cushions.

The adjustable bow and stern seal systems may be flexible membranes, as in finger and bag systems used on some types of SES. In other embodiments, they may be flexible plates otherwise known as compliant mechanisms. They may also be louvers or plates mounted on multilink articulations and hence are no longer simple flaps. The plates may be flat or curved and mounted on single or multilink articulations. The bow and stern seals may also be obtained by the use of intangible seals such as planar air jets. A planar air jet may be formed by a linear nozzle or slit at the fore of the DACV. This relatively thin layer of fast-moving air may effectively maintain a separation between the ambient pressure on one side of the planar air jet, and the air cushion's desired pressure on the other side. The planar air jet may be referred to as an air curtain.

When stationary or at low speeds, the bow seal may not need to be completely closed in some embodiments, or may be completely open.

Features from any of the embodiments may be combined with features from any of the other embodiments to form another embodiment within the scope of the invention. Some embodiments, depending on their configuration, may exhibit all or fewer than all of the advantages described herein. Other advantages not mentioned may be present in one or more of the embodiments.

All values, parameters, proportions and configurations described herein are examples only and may be changed depending on the specific embodiment implemented. In general, unless otherwise indicated, singular elements may be in the plural and vice versa with no loss of generality.

Throughout the description, specific details have been set forth to provide a more thorough understanding of embodiments of the invention. However, the invention may be practised without these specific details. In other instances, well known elements have not been shown or described in detail and repetitions of features have been omitted to avoid unnecessarily obscuring the invention. Accordingly, the specification and drawings are to be regarded in an illustrative, rather than a restrictive, sense. It will be clear to one having skill in the art that variations to the details disclosed herein can be made, resulting in other embodiments that are within the scope of the invention disclosed. Accordingly, the scope of the invention is to be construed in accordance with the substance defined by the claims.

1. A method of operating a dynamic air cushion vehicle (DACV), the DACV having a fan, an air cushion, an adjustable bow seal and an adjustable stern seal, the method comprising:
drawing air into the air cushion via the fan;
drawing ram air into the air cushion via a controlled opening in the adjustable bow seal; and
expelling the air and the ram air from the air cushion via another controlled opening, which is in the adjustable stern seal.

2. The method of claim 1, wherein the DACV is operated on water, land or ice.

3. The method of claim 1 further comprising controlling, using a computer, said drawing of the air into the air cushion, said drawing of ram air into the air cushion and said expelling the air and the ram air from the air cushion.

4. The method of claim 3, further comprising:
driving the DACV forwards at a desired speed; while
balancing, by the computer, said drawing of the air into the air cushion, said drawing of ram air into the air cushion and said expelling the air and the ram air from the air cushion to minimize a rotational speed of the fan.

5. The method of claim 1, wherein the DACV has two hulls each of which retains a different side of the air cushion.

6. The method of claim 1, wherein the fan is located at a front of the DACV.

7. The method of claim 1 further comprising increasing a thrust force of the DACV by increasing the controlled opening of the adjustable bow seal.

8. The method of claim 1 further comprising decreasing a thrust force of the DACV by decreasing the controlled opening of the adjustable bow seal.

9. The method of claim 1 further comprising, while the adjustable bow seal is open, decreasing a thrust force of the DACV by decreasing an air flow through the fan.

10. The method of claim 1 further comprising, while the adjustable bow seal is open, increasing a thrust force of the DACV by increasing an air flow through the fan.

11. The method of claim 1 further comprising, while the adjustable bow seal is open, maintaining a speed of the DACV constant by:
drawing more ram air into the air cushion; and simultaneously
reducing a rotational speed of the fan.

12. The method of claim 1 further comprising controlling the air cushion to provide a desired lift for the DACV and a desired thrust for the DACV, wherein controlling the air cushion comprises setting:
a rotational speed of the fan and/or a blade pitch of the fan;
the controlled opening of the adjustable bow seal; and
the controlled opening of the adjustable stern seal;
so that an efficiency of the DACV is optimized.

13. A dynamic air cushion vehicle (DACV) comprising:
a fan that blows air into an air cushion;
an adjustable bow seal with a controlled opening that controls a flow of ram air into the air cushion;
an adjustable stern seal, with another controlled opening, which controls a flow of the air and the ram air out of the air cushion; and
a control unit that controls:
a rotational speed of the fan and/or a blade pitch of the fan;
the controlled opening of the adjustable bow seal; and
the controlled opening of the adjustable stern seal.

14. The DACV of claim 13, wherein the adjustable bow seal seal comprises a flap, a rigid plate, a flexible plate, a flexible membrane, louvers, multiple flat plates or one or more curved plates.

15. The DACV of claim 13, wherein the adjustable stern seal comprises a flap, a rigid plate, a flexible plate, a flexible membrane, louvers, multiple flat plates or one or more curved plates.

16. The DACV of claim 13, wherein the adjustable bow seal comprises a planar air jet.

17. The DACV of claim 13, wherein the adjustable stern seal comprises a planar air jet.

18. The DACV of claim 13, wherein the control unit controls:
the controlled opening of the adjustable bow seal;
the controlled opening of the adjustable stern seal; and
the rotational speed of the fan and/or the blade pitch of the fan;
to optimize an efficiency of the DACV for a desired thrust of the DACV and a desired lift of the DACV.

19. The DACV of claim 13, further comprising an aerofoil-shaped roof.
